(19) United States
(12) Patent Application Publication
(10) Pub. No.: US 2013/0264532 A1
(43) Pub. Date: Oct. 10, 2013

(54) Screwless Retaining Bar

(71) Applicant: Robert Sherman Goodman, East Haven, CT (US)

(72) Inventor: Robert Sherman Goodman, East Haven, CT (US)

(21) Appl. No.: 13/440,671

(22) Filed: Apr. 5, 2012

(51) Int. Cl. E04H 17/20; B23P 11/00

(52) U.S. Cl. 256/65.08; 256/65.03; 29/557; 29/428

(57) ABSTRACT

An improved fence assembly and method of manufacture and assembly of a fence that does not require fasteners. The fence assembly and method includes a retaining element that does not use fasteners and allows the vertical posts of the fence to rotate with respect to the horizontal rails of the fence, so that the fence can be installed on an uneven surface.

### FIELD OF THE INVENTION

The present invention relates to an improved fence assembly having a retaining bar located within horizontal rails of a fence, the retaining bar not having fasteners to secure the horizontal rails of a fence to its vertical posts.

### BACKGROUND OF THE INVENTION

Fences having intersecting vertical posts and horizontal rails have recently become popular and are strong, durable and attractive, while requiring little or no maintenance. In most fence designs, fences use fasteners, such as screws, to fix a plurality of horizontal to rails to a plurality of vertical posts. A disadvantage to these designs that use fasteners is that the fasteners often rust and corrode. Further, it is difficult to assemble fences using screws, as it is hard to tighten the screws in the rails to attach the rails to vertical posts. Moreover, if screws are used, then the fence cannot rotate, thus, making it difficult to set the fences on uneven surfaces.

There are various designs for fences having vertical posts and horizontal rails known in the prior art. U.S. Pat. No. 7,384,025 to Lo, U.S. Pat. No. 7,347,412 to Zhu and U.S. Pat. No. 6,173,944 to McCarthy all have screws engaging the coupling bars. While the screws are hidden in these designs, these designs suffer from having the screws rust and corrode, and these fence designs are difficult to assemble.

U.S. Pat. No. 5,454,548 to Moore is a fence design having a solid coupling bar with locking means that firmly locks the rails into pickets forming a rigid structure and thus not enabling any rotation of the rails with the pickets or posts. U.S. Pat. No 6,375,166 to Schall et al. uses inserts with legs for attachment; U.S. Pat. No. D479,612 to Larsen et al. and U.S. Pat. No. 6,969,051 to Gibbs use a locking rod; U.S. Pat. No. 7,021,607 to Alexander uses clips having flaps for attachment; and U.S. Pat. No. 6,752,386 to Bundy uses a sliding lockbar for attachment.

Another design, the Corigin™ system from Activeyards™ provides a system having horizontal rails and vertical posts where the rails are shown having a punched portion in the rails for connecting the horizontal rails to the vertical posts.

FIG. 23 shows a detailed cross-section view of the Corigin™ system that is known in the prior art. FIG. 23 provides horizontal rail 2320, vertical post 2330 and retaining element 2340 having punched portion 2345.

FIG. 23 further shows vertical post 2330 and retaining element 2340 being located within aperture 2310 of horizontal rail 2320. Retaining element 2340 is shown located between upper support ridge 2360, middle support ride 2365 and lower support ridge 2375. These support ridges hold retaining element 2340 in place.

Furthermore, vertical post 2330 is shown having its sides abut upper support ridge 2350 and lower support ridge 2355. Retaining element 2340 is shown engaging or being engageable with vertical post 2330. Specifically, retaining element 2340 has a punched portion 2345 that is punched in and is engageable with an opening 2380 in vertical post 2330. The engagement of the punched portion 2345 with hole 2380 allows vertical post 2330 to be engaged with horizontal rail 2320.

FIG. 24 is a further view of the detailed cross-section view of FIG. 24 after being rotated along axis 24-24. Here, punched portion 2345 is shown in hole 2380. Vertical post 2330 is shown in aperture 2310 of horizontal rail 2320.

The Corigin™ design, however, suffers from various deficiencies that are overcome by the present invention. The Corigin™ design cannot fully and freely rotate. Moreover, the Corigin™ design requires an extra step of punching holes in the retaining element, which makes it more difficult to manufacture as the punched portion needs to be lined up with the holes in the vertical posts during manufacturing. The Corigin™ design is exhibits greater wear and tear than the presently claimed invention and has less structural strength as the punched portions are subject to stresses that can cause the fence to deteriorate over time. Structural strength and integrity is important for fence design and the Corigin™ design has weak structural strength and integrity in this regard.

What is desired therefore is to provide a fence assembly and method that does not use fasteners and has a retaining bar in the assembly that allows for free and easy rotation of the vertical posts with respect to the horizontal rails. It is further desirable to develop a fence assembly and method that provides for rotation of the vertical posts with respect to the horizontal rails allowing for assembly of the fence on an uneven surface. It is further desirable to develop a fence assembly and method that allows for structural strength and integrity of all elements of the fence including the retaining bar. It is further desirable to provide a method for manufacturing a retaining bar for a fence that does not involve punching portions of the retaining bar, which weakens the structural strength and integrity of the bar.

### SUMMARY OF THE INVENTION

Accordingly, it is an object of the present invention to provide a fence assembly that does not use fasteners and has a retaining bar in the assembly that allows for free rotation of the vertical posts with respect to the horizontal rails. It is a further object of the present invention to provide a fence assembly that provides for rotation of the vertical posts with respect to the horizontal rails allowing for assembly of the fence on an uneven surface.

It is a further object of the present invention to provide a fence assembly that has its retaining bar manufactured as one piece, rather than having the retaining bar require have punched portions that affect the overall strength and stability of the retaining bar. It is a further object of the present invention to provide a fence assembly and method that allows for structural strength and integrity of all elements of the fence including the retaining bar.

These and other objectives are achieved by providing a fence comprising: one or more horizontal rails, each of the one or more horizontal rails having one or more apertures extending through the one or more horizontal rails; one or more vertical posts, each of the one or more vertical posts passing through the one or more apertures, each of the one or more vertical posts having one or more openings and having one or more walls; one or more retaining elements, each of the one or more retaining elements having a ledge portion and a base portion, the ledge portion of the one or more retaining elements having one or more cavities, the one or more cavities dividing the ledge portion into one or more large sections and one or more smaller sections, the one or more larger sections being separated from the one or more smaller sections by the one or more cavities, wherein the one or more smaller sections are engaged with the one or more openings in the one or more vertical posts to secure the one or more vertical posts to the one or more horizontal rails.

In certain embodiments, the ledge portion of the one or more retaining elements is not continuous along the entire length of the one or more retaining elements. Rather the ledge portion is divided into pieces (one or more larger sections and smaller sections) allowing for the smaller sections it to interact with the one or more vertical posts.

In certain embodiments, the fence may include two upper support ridges and two lower support ridges located on each of the one of more horizontal rails. In other embodiments, only some of the one or more horizontal rails have two upper support ridges and two lower support ridges. In other embodiments, there may be just one upper support ridge, just two upper support ridges, or one upper support ridge and one lower support ridge, or two upper support ridges and one lower support ridge. Other combinations are possible whereby a middle ridge may be provided.

In some embodiments, the base portion of each of the one or more retaining elements extends vertically between one of the upper support ridges and one of the lower support ridges of each of the one or more horizontal rails to maintain the one or more retaining elements between one of the upper support ridges and one of the lower support ridges of each of the one or more horizontal rails. This allows for the retaining element to be secured within the one or more horizontal rails.

In some embodiments, the ledge portion of each of the one or more retaining elements extends horizontally away from the base portion of each of the one or more retaining elements. In other embodiments, the ledge portion may extend horizontally, but may be angled, so that it can engage with openings in the one or more vertical posts.

In certain embodiments, the two upper support ridges of each of the one or more horizontal rails are engageable with the one or more vertical posts. This allows the one or more vertical posts to be held in place by the two upper support ridges, and provides structural strength to the fence, preventing or mitigating the one or more vertical posts from rotating with respect to the one or more horizontal rails.

In certain embodiments, the one or more larger sections of the ledge portion of the one or more retaining elements prevent the one or more vertical posts from rotating once one of the one or more walls of the one or more vertical posts press against an edge of the one or more larger sections.

In other embodiments, the engagement of the one or more smaller sections with the one or more openings in the one or more vertical posts allows the fence to rotate. The fence can rotate up to 80 degrees though it is preferable for the fence to only rotate up to about 45 degrees. The rotation of the fence allows it to be efficiently installed on uneven surfaces.

In other embodiments, each of the one or more larger sections and each of the one or more smaller sections of the ledge portion of each of the one or more retaining elements has a rectangular shape. The one or more larger sections and the one or more smaller sections may have alternative shapes, such as squares, triangles, rectangles or trapezoids in other embodiments.

In certain embodiments, the fence may include each of the one or more horizontal rails having three sides and be U-shaped. In other embodiments, each of the one or more the vertical posts may have four sides and may have a rectangular shape. The openings in the one or more vertical posts may be circular or round. The fence may be modular and may be located on an uneven surface.

In certain embodiments, the one or more horizontal rails may engageable with a clip, the clip being engageable with a post.

Other objects of the invention are achieved by providing a retaining element for a fence comprising: a base portion that extends vertically; and a ledge portion that extends horizontally, the ledge portion having one or more cavities, the one or more cavities dividing the ledge portion into one or more larger sections and one or more smaller sections, the one or more larger sections being separated from the one or more smaller sections by the one or more cavities, wherein at least one of the one or more smaller sections is engageable with an opening in a component of the fence. Here, the ledge portion of the retaining element is not continuous along the entire length of the retaining element.

In certain embodiments, the one or more larger sections prevent the fence from rotating once a wall of a vertical post of the fence presses against an edge of the one or more of larger sections of the ledge portion of the retaining element.

In certain embodiments, each of the one or more small sections and the one or more larger sections of the ledge portion of the retaining element has a rectangular shape.

In certain embodiments, the base portion has a greater thickness at the bottom of the base portion than at the top of the base portion. The base portion may sit or be engageable with a lower support ridge of a horizontal rail.

In certain embodiments, the base portion may extend between an upper support ridge and a lower support ridge of a horizontal rail to attach the retaining element to the horizontal rail.

Other objects of the invention are achieved by providing a method of manufacturing a retaining element for a modular fence comprising the steps of: providing a retaining element comprising a base portion, the base portion extending vertically and the ledge portion extending horizontally away from the base portion; and machining cavities in the ledge portion, so that the ledge portion is divided into individual sections, the individual sections composed of alternating larger sections and smaller sections.

The method may have the alternating larger sections and smaller sections be equidistant from one another. The retaining element may be made from a single piece of material.

Other embodiments may have the ledge portion welded onto the base portion. This embodiment may have the retaining element manufactured without machining the retaining element, but rather may only involve steps of welding the ledge portion onto the base portion.

Other objects of the invention are achieved by providing a method of installation of a modular fence comprising the steps of: providing one or more one or more horizontal rails, each of the one or more horizontal rails having one or more apertures extending through the one or more horizontal rails; providing one or more vertical posts, each the one or more vertical posts having one or more openings; providing one or more retaining elements, each of the one or more retaining elements having a ledge portion and base portion, the ledge portion of the one or more retaining elements having one or more cavities, the one or more cavities dividing the ledge portion of the one or more retaining elements into one or more larger sections and one or more smaller sections, the one or more larger sections being separated from the one or more smaller sections by the one or more cavities; disposing each of the one or more vertical posts through one of the apertures extending through the one or more horizontal rails; disposing the one or more retaining elements within the one or more horizontal rails; and engaging the one or more small sections of the ledge portion of the one or more retaining elements with the one or more openings in the one or more vertical posts to secure the one or more vertical posts to the one or more horizontal rails.

The method may involve each of the one or more horizontal rails having two upper support ridges and two lower support ridges, where the base portion of each of the one or more retaining elements extends between the upper support ridges and the lower support ridges of the one or more horizontal rails to maintain the one or more retaining elements between one of the upper support ridges and one of the lower support ridges of each of the one or more horizontal rails.

Other embodiments involve the fence being installed on an uneven surface.

Other embodiments involve a step of further rotating the one or more vertical posts with respect to the one or more horizontal rails until the one or more horizontal rails are parallel to the surface.

Other embodiments involve the steps of providing a clip and two posts; engaging the one or more horizontal rails with the clip; and engaging the clip with the post to provide structural support to the fence.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention

### BRIEF DESCRIPTION OF THE DRAWINGS

FIG. 1 is a perspective view of a fence of an embodiment of the present invention;

FIG. 2 is a perspective view of a horizontal rail of the embodiment of the present invention shown in FIG. 1;

FIG. 3 is a top view of the horizontal rail of FIG. 2;

FIG. 4 is a bottom view of the horizontal rail of FIG. 2;

FIG. 5 is a side view of the horizontal rail of FIG. 2;

FIG. 6 is a perspective view of a vertical post of the embodiment of the present invention shown in FIG. 1;

FIG. 7 is a side view of the vertical post of FIG. 6;

FIG. 8 is top view of the vertical post of FIG. 6;

FIG. 9 is a perspective view of a retaining element of the embodiment of the present invention shown in FIG. 1;

FIG. 10 is a detailed side view of the retaining element of FIG. 9;

FIG. 11 is a top view of the retaining element of FIG. 9;

FIG. 12 is a side view of the retaining element of FIG. 9;

FIG. 13 is a detailed side view of the horizontal rail and vertical post of the embodiment of the present invention shown in FIG. 1;

FIG. 14 is a top view of the horizontal rail and vertical post of FIG. 13;

FIG. 15 is a detailed cross-section view of the horizontal rail, vertical post and retaining element assembly of the embodiment of the present invention shown in FIG. 1;

FIG. 16 is a detailed cross-section view of the horizontal rail, vertical post and retaining element assembly of FIG. 15 after being rotated;

FIG. 17 is a top detailed cross-section view of the horizontal rail, vertical post and retaining element assembly of FIG. 15;

FIG. 18 is a detailed cross-section view of the horizontal rail, vertical post and retaining element assembly of FIG. 16;

FIG. 19 is a detailed cross-section view of the horizontal rail, vertical post and retaining element assembly of FIG. 18 where the vertical post is rotated;

FIG. 20 is a detailed cross-section view of the horizontal rail, vertical post and retaining element assembly of FIG. 18 where the vertical post is rotated until its side hits the edge of the larger section of the retaining element;

FIG. 21 is a perspective view of the horizontal rail and clip of the embodiment of the present invention shown in FIG. 1;

FIG. 22 is a perspective view of various modules of a fence of the present invention;

FIG. 23 is a detailed cross-section view of the horizontal rail, vertical post and retaining element assembly of the prior art Corigin™ design; and

FIG. 24 is a detailed cross-section view of the horizontal rail, vertical post and retaining element assembly of the prior art Corigin™ design after being rotated.

### DETAILED DESCRIPTION OF THE INVENTION

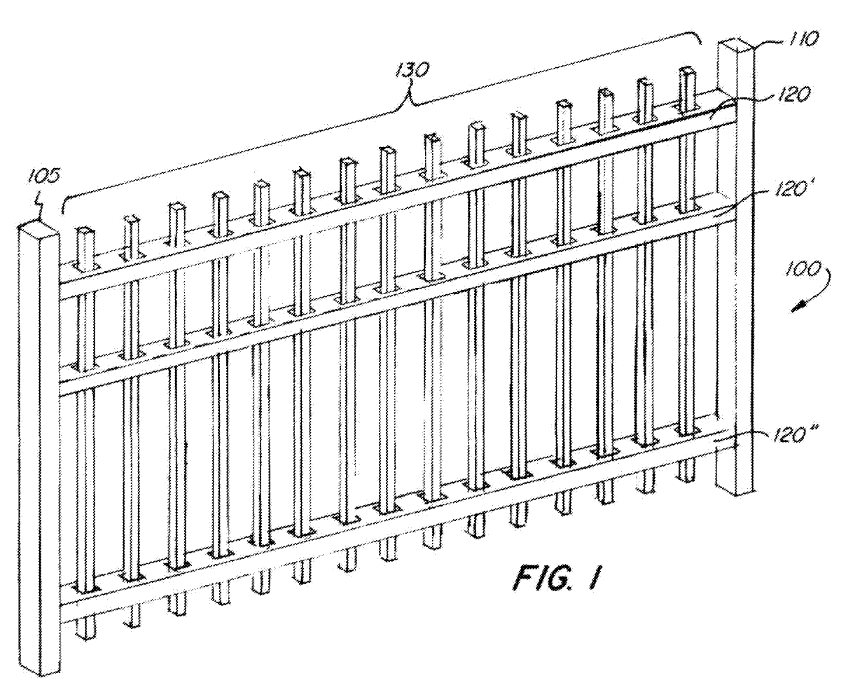

Referring to FIG. 1, a fence assembly 100 in accordance with the present invention is shown. The fence assembly 100 has vertical posts 130 shown and horizontal rails 120, 120′ and 120.″ Also shown are end posts 105 and 110. The assembly may have a greater number or a small number of horizontal rails and/or vertical posts than shown in FIG. 1.

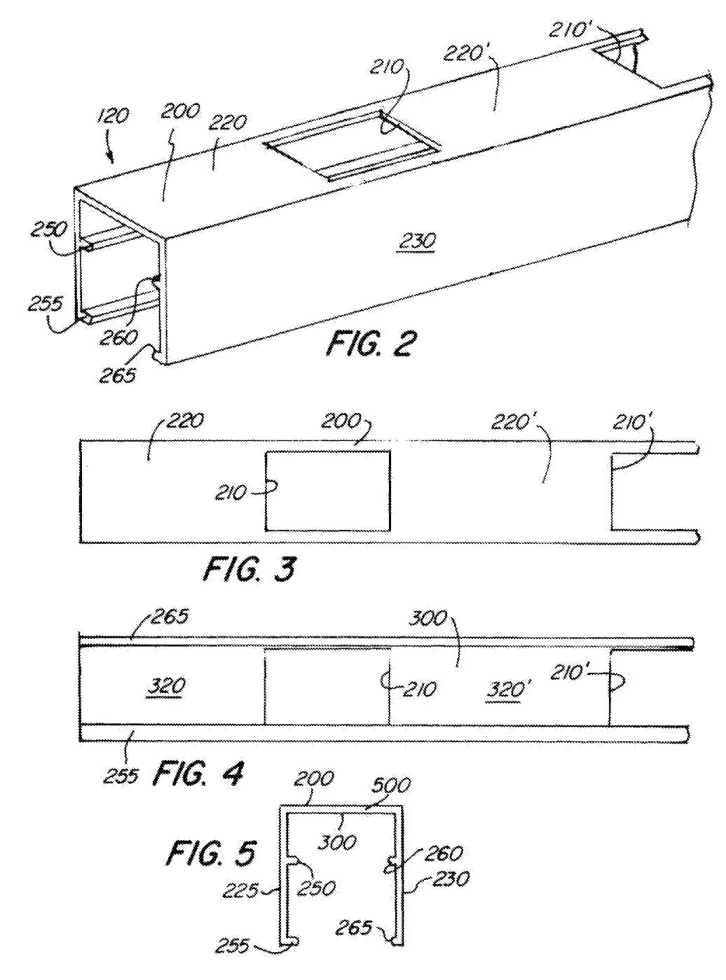

FIG. 2 is a perspective view of horizontal rail 120 of FIG. 1. FIG. 2 shows horizontal rail 120 having top surface 200, which is divided into sections 220 and 220′ by apertures 210 and 210′ extending through horizontal rail 120. Also shown are side surface 230 and the internal components of the rail. Upper support ridges 250 and 260 and lower support ridges 255 and 265 are shown in FIG. 2. These support ridges are shown extending horizontally or into the center of the interior of horizontal rail 120.

FIGS. 3-5 show other views of horizontal rail 120. Shown in these figures are apertures 210 and 210′, although additional apertures may be present in a horizontal rail. Also shown is the bottom surface 300 of the horizontal rail 120, which is divided into sections 320 and 320′ by apertures 210 and 210′ extending through horizontal rail 120. Also shown is a side view of horizontal rail 120, side faces 225/230 and top face 500.

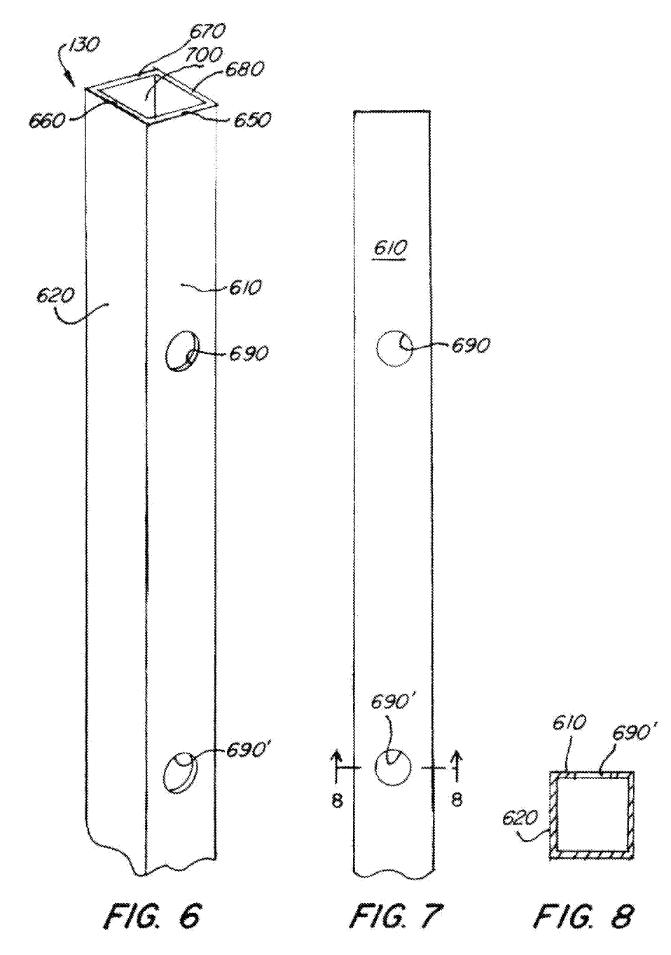

FIG. 6 is a perspective view of vertical post 130. Vertical post 130 is shown having side surfaces 610, 620 and two other surfaces which are not numbered. The top of the vertical post is shown having sides 650, 660, 670 and 680. Also openings 690 and 690′ are shown. These openings are shown being circular, although the openings may be other shapes such as being round, rectangular, oval, pentagonal, or may be additional shapes.

FIGS. 7 and 8 shown front surface 610 with openings 690 and 690′ as well as a top view of the vertical post 130.

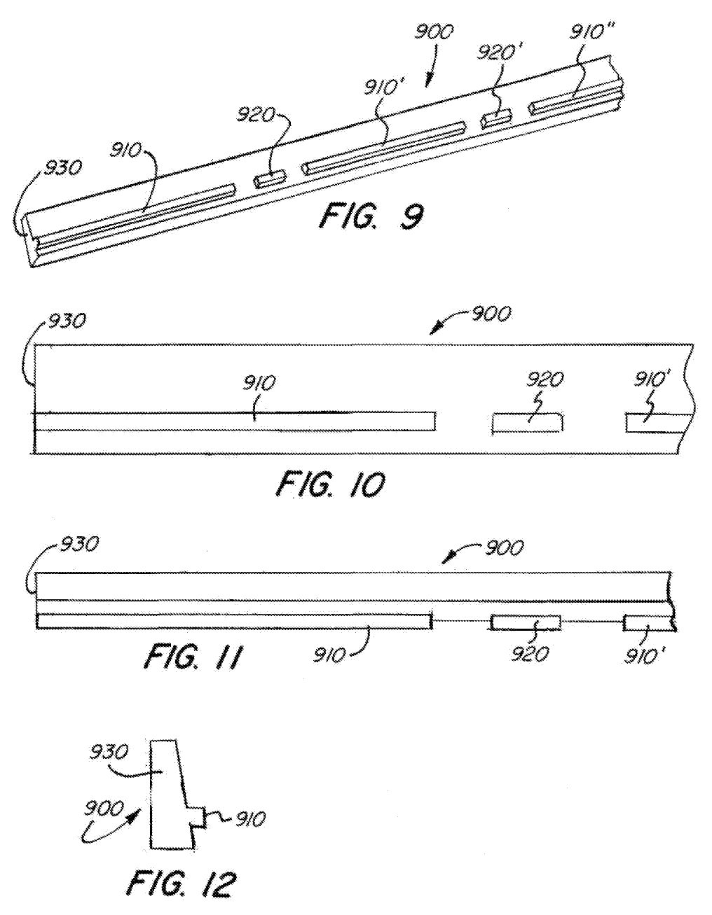

FIG. 9 is a perspective view of retaining element 900 of an embodiment of the invention. FIG. 9 shows base portion 930 and ledge portions 910, 910′, 910″, 920 and 920′. The ledge portions 910, 910′, 910″ are the larger portions and 920 and 920′ are the small portions of the ledge section. A greater or smaller number of ledge portions may be provided for the retaining bar than shown in FIG. 9.

Base portion 930 is shown being vertical. Ledge portions 910, 910′, 910″, 920 and 920′ are shown extending horizontally from the base portion 930. In FIG. 12, base portion 930 is shown being angled and having a greater thickness at the bottom of the base portion than at the top. However, the base portion 930 may not be angled in certain embodiments. The ledge portions may be shown either angled up or down, but still extending away from the base portion.

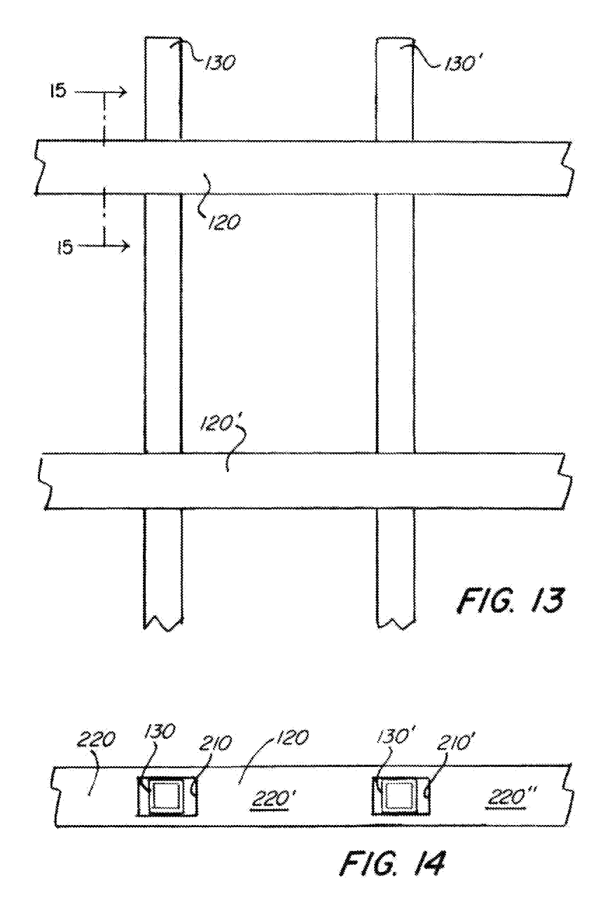

FIG. 13 is a detailed view of horizontal rails 120, 120′ and vertical posts 130, 130′ in an assembled state. Here, it is shown that the vertical posts 130, 130′ are located within horizontal rails 120, 120′. This is further shown in FIG. 14 where vertical posts 130, 130′ are located with apertures 210, 210′ of the horizontal rail 120. The top surface 220, 220′ and 220″ is also shown in this figure.

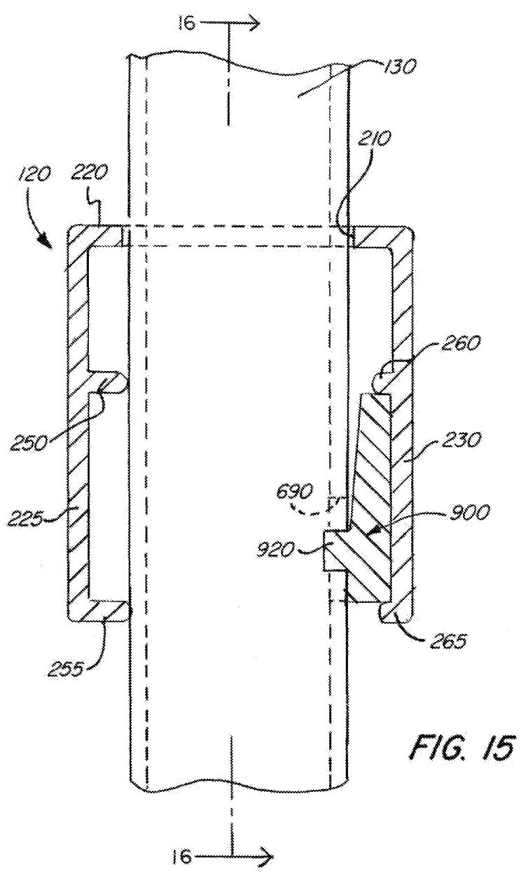

FIG. 15 shows a detailed cross-section view of horizontal rail 120, vertical post 130 and retaining element 900 of an embodiment of the present invention shown in FIG. 1. Here, vertical post 130 and retaining element 900 are shown being located within aperture 210 of the horizontal rail 120. Retaining element 900 is shown located between upper support ridge 260 and lower support ridge 265. These support ridges hold or maintain the retaining element 900 in place.

Furthermore, vertical post 130 is shown having its sides abut upper support ridge 250 and lower support ridge 255. Retaining element 900 is shown engaging or being engageable with vertical post 130. Specifically, the ledge portion 920 is engageable with opening 690 in vertical post 130.

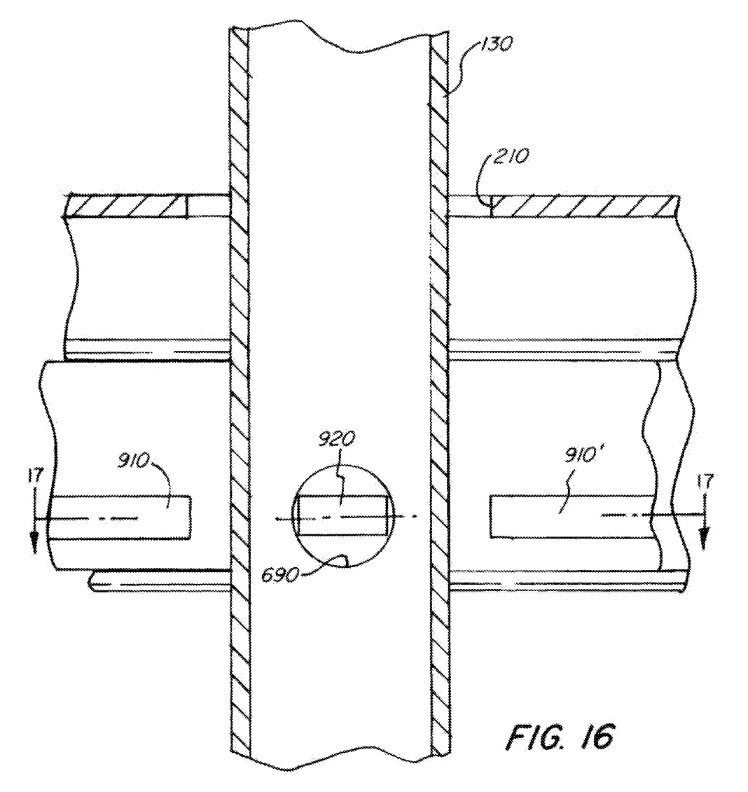

FIG. 16 is a further view of the detailed cross-section view of FIG. 15 after being rotated. Here, ledge portions 910, 910′ and 920 are shown. Ledge portion 920 is shown being located within opening 690. The edges of ledge portion 920 are shown abutting against opening 690, however, enough space is left so that vertical post 130 can rotate.

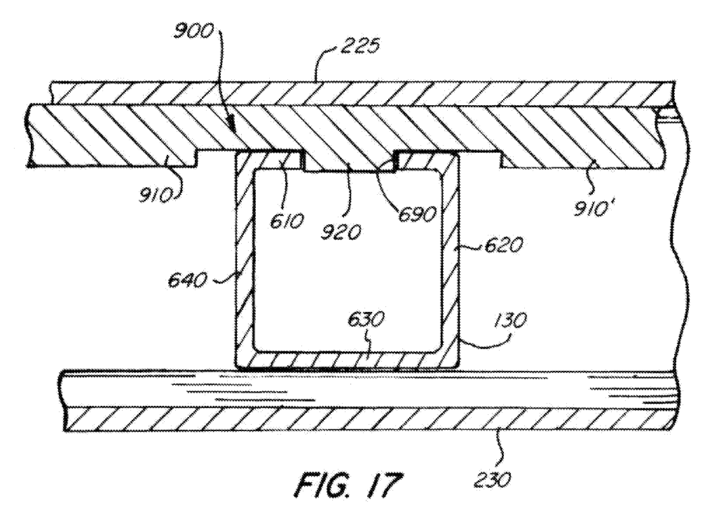

FIG. 17 is a top detailed cross-section view of FIG. 15. Here, the side surfaces 610, 620, 630 and 640 are shown as well as ledge portions 910, 910′ and 920, retaining element 900 and the sides 225, 230 of horizontal rail 120.

FIG. 17 shows how ledge portion 920 is located within opening 690. Ledge portions 910 and 910′ are also shown in this figure.

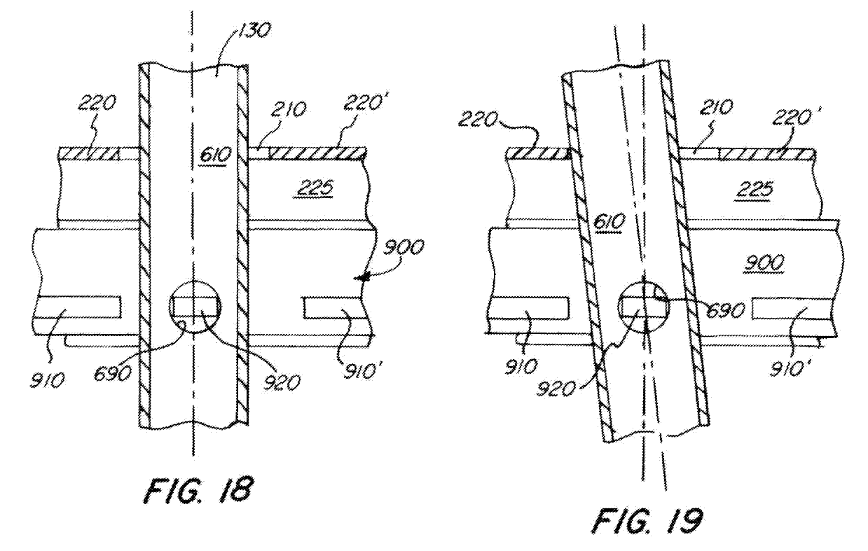

FIGS. 18-19 show the rotation of vertical post 130 within horizontal rail 120. FIG. 18 shows vertical post 130 being perpendicular to horizontal rail 120. FIG. 19 shows vertical post 130 being rotated away from being perpendicular to horizontal rail 120. FIGS. 18-19 also show the face 610 of vertical post 130 as well as other elements previously described in other figures. Allowing for the vertical post 130 to rotate with respect to horizontal rail 120 is one of the objects of the invention as it allows the fence to rest on uneven surfaces. Moreover, such rotation is free and easy, through providing an advantage during assembly.

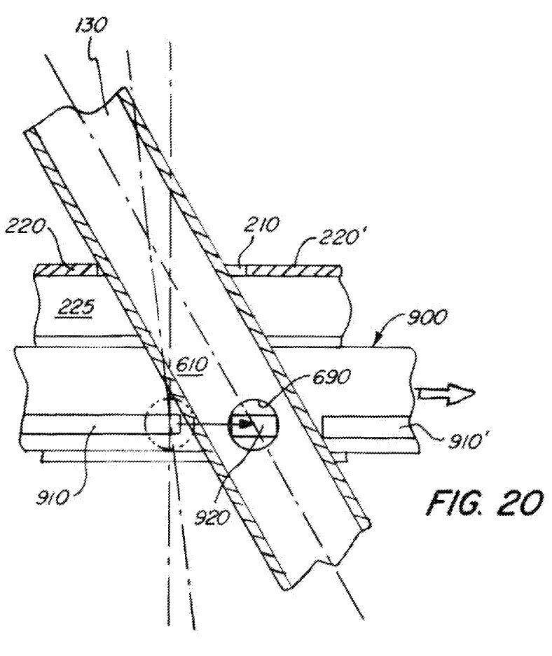

FIG. 20 shows vertical post 130 being rotated away from being perpendicular to horizontal rail 120 until the side of vertical post 610 hits the edge of ledge portion 910. This stops the vertical post from being further rotated. In certain embodiments, the amount of rotation of vertical post varies, but is not more than eighty degrees.

FIG. 22 is a perspective view of the horizontal rail 2200. Horizontal rail 2200 is shown having upper support ridges 2250 and 2260 and being connected to clip 2210. Clip 2210 has an indent 2225 and vertical opening 2215 to allow a stake (not shown) to be inserted vertically through vertical opening 2115.

The clip 2210 is connected to horizontal rail 2200 through a barb 2220, which fits into bore 2230 on the horizontal rail 2200.

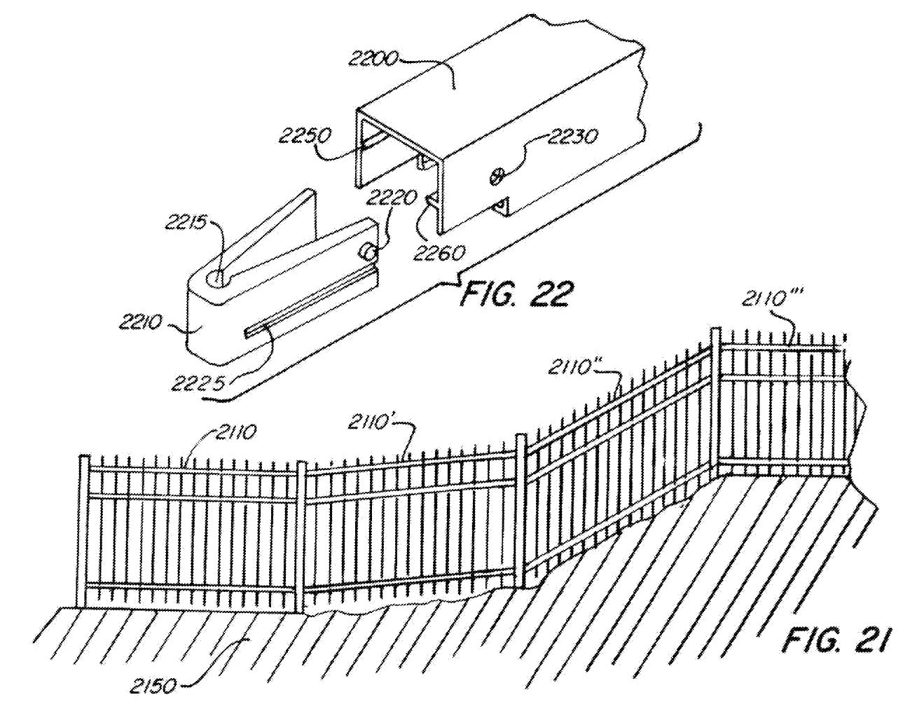

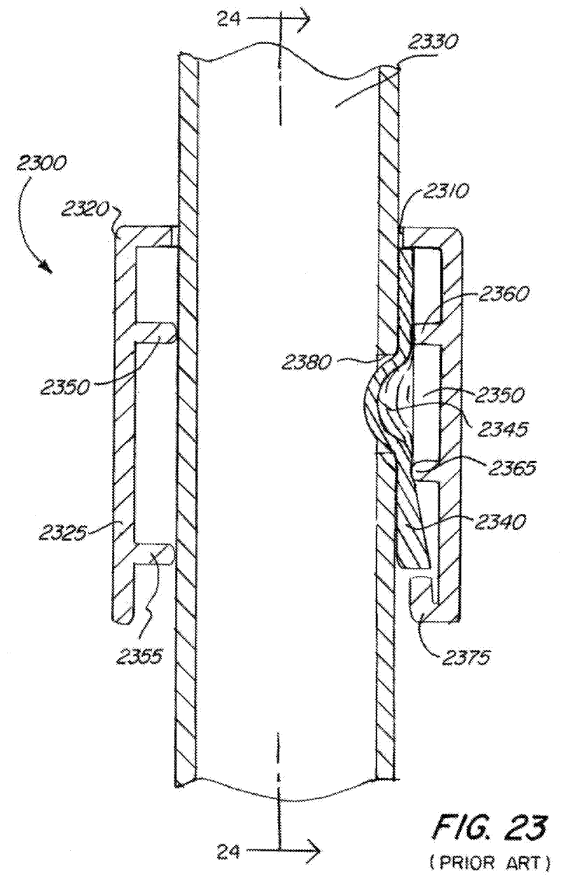

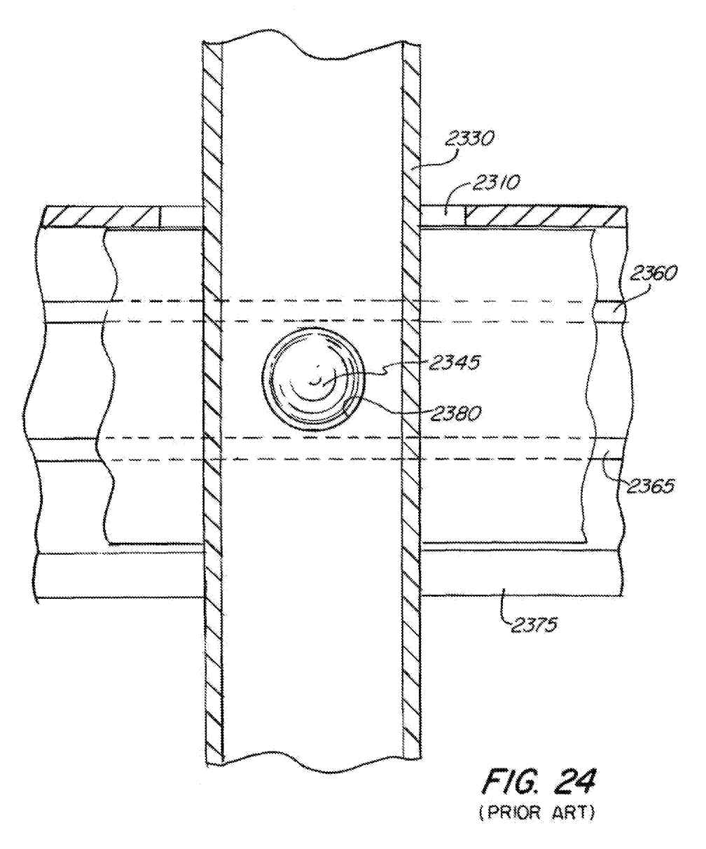

FIG. 21 shows fence sections 2110, 2110′, 2110″ and 2110′″, which are located on uneven surface 2150. The fence sections are modular and have stakes in between each modular section.

While the invention has been specifically described in connection with certain specific embodiments thereof, it is to be understood that this is by way of illustration and not of limitation and that various changes and modifications in form and details can be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A fence comprising:
one or more horizontal rails, each of the one or more horizontal rails having one or more apertures extending through the one or more horizontal rails;
one or more vertical posts, each of the one or more vertical posts passing through the one or more apertures, each of the one or more vertical posts having one or more openings and having one or more walls;
one or more retaining elements, each of the one or more retaining elements having a base portion and a ledge portion, the ledge portion of the
one or more retaining elements having one or more cavities, the one or more cavities dividing the ledge portion into one or more larger sections and one or more smaller sections, the one or more larger sections being separated from the one or more smaller sections by the one or more cavities,
wherein the one or more smaller sections are engaged with the one or more openings in the one or more vertical posts to secure the one or more vertical posts to the one or more horizontal rails.

2. The fence of claim 1, wherein each of the one of more horizontal rails have two upper support ridges and two lower support ridges.

3. The fence of claim 2, wherein the base portion of each of the one or more retaining elements extends vertically between one of the upper support ridges and one of the lower support ridges of each of the one or more horizontal rails to maintain the one or more retaining elements between one of the upper support ridges and one of the lower support ridges of each of the one or more horizontal rails.

4. The fence of claim 1, wherein the ledge portion of each of the one or more retaining elements extends horizontally away from the base portion of each of the one or more retaining elements.

5. The fence of claim 2, wherein the two upper support ridges of each of the one or more horizontal rails are engageable with the one or more vertical posts.

6. The fence of claim 1, wherein the one or more larger sections of the ledge portion of the one or more retaining elements prevent the one or more vertical posts from rotating once one of the one or more walls of the one or more vertical posts press against an edge of the one or more larger sections.

7. The fence of claim 1, wherein the engagement of the one or more smaller sections with the one or more openings in the one or more vertical posts allows the fence to rotate.

8. The fence of claim 1, wherein each of the one or more larger sections and each of the one or more smaller sections has a rectangular shape.

9. The fence of claim 1, wherein each of the one or more horizontal rails has three sides and is U-shaped.

10. The fence of claim 1, wherein each of the one or more the vertical posts has four sides and has a rectangular shape.

11. The fence of claim 10, wherein the openings in the one or more vertical posts are circular or round.

12. The fence of claim 1, wherein the one or more vertical posts can rotate from 0 degrees to 80 degrees.

13. The fence of claim 1, wherein the fence is modular.

14. The fence of claim 1, wherein the fence is located on an uneven surface.

15. The fence of claim 1, wherein the one or more horizontal rails is engageable with a clip, the clip being engageable with a post.

16. The fence of claim 1, wherein the base end of the ledge portion of the one or more retaining elements is perpendicular to the base portion.

17. A retaining element for a fence comprising:
a base portion that extends vertically; and
a ledge portion that extends horizontally, the ledge portion having one or more cavities, the one or more cavities dividing the ledge portion into one or more larger sections and one or more smaller sections, the one or more larger sections being separated from the one or more smaller sections by the one or more cavities,
wherein at least one of the one or more smaller sections is engageable with an opening in a component of a fence.

18. The retaining element of claim 17, wherein the one or more larger sections prevent the fence from rotating once a wall of a vertical post of the fence presses against an edge of the one or more of larger sections of the ledge portion of the retaining element.

19. The retaining element of claim 17, wherein each of the one or more small sections and the one or more larger sections of the ledge portion of the retaining element has a rectangular shape.

20. The retaining element of claim 17, wherein the base portion has a greater thickness at the bottom of the base portion than at the top of the base portion.

21. The retaining element of claim 17, wherein the base portion extends between an upper support ridge and a lower support ridge of a horizontal rail to attach the retaining element to the horizontal rail.

22. A method of manufacturing a retaining element for a modular fence comprising the steps of:
providing a retaining element comprising a base portion and a ledge portion, the base portion extending vertically and the ledge portion extending horizontally away from the base portion; and
machining cavities in the ledge portion, so that the ledge portion is divided into individual sections, the individual sections composed of alternating larger sections and smaller sections.

23. The method of claim 22, wherein the alternating larger and smaller sections are equidistant from one another.

24. The method of claim 22, wherein the retaining element is made from a single piece of material.

25. A method of installation of a modular fence comprising the steps of:
providing one or more one or more horizontal rails, each of the one or more horizontal rails having one or more apertures extending through the one or more horizontal rails;
providing one or more vertical posts, each the one or more vertical posts having one or more openings;
providing one or more retaining elements, each of the one or more retaining elements having a ledge portion and base portion, the ledge portion of the one or more retaining elements having one or more cavities, the one or more cavities dividing the ledge portion of the one or more retaining elements into one or more larger sections and one or more smaller sections, the one or more larger sections being separated from the one or more smaller sections by the one or more cavities;
disposing each of the one or more vertical posts through one of the apertures extending through the one or more horizontal rails;
disposing the one or more retaining elements within the one or more horizontal rails; and
engaging the one or more small sections of the ledge portion of the one or more retaining elements with the one or more openings in the one or more vertical posts to secure the one or more vertical posts to the one or more horizontal rails.

26. The method of claim 25, wherein each of the one or more horizontal rails has two upper support ridges and two lower support ridges, and wherein the base portion of each of the one or more retaining elements extends between the upper support ridges and the lower support ridges of the one or more horizontal rails to maintain the one or more retaining elements between one of the upper support ridges and one of the lower support ridges of each of the one or more horizontal rails.

27. The method of claim 25, wherein the fence is installed on an uneven surface.

28. The method of claim 26, further comprising rotating the one or more vertical posts with respect to the one or more horizontal rails until the one or more horizontal rails are parallel to the surface.

29. The method of claim 25, further comprising:
providing a clip and two posts;
engaging the one or more horizontal rails with the clip; and
engaging the clip with the post to provide structural support to the fence.
